(19) United States
(12) Patent Application Publication
(10) Pub. No.: US 2018/0342762 A1
(43) Pub. Date: Nov. 29, 2018

(54) NONAQUEOUS ELECTROLYTE SECONDARY BATTERY

(71) Applicant: Sumitomo Chemical Company, Limited, Tokyo (JP)

(72) Inventors: Ichiro ARISE, Osaka (JP); Chikara MURAKAMI, Osaka (JP)

(21) Appl. No.: 15/988,650

(22) Filed: May 24, 2018

(30) Foreign Application Priority Data
May 26, 2017 (JP) 2017-105074

(51) Int. Cl. H01M 10/0525; H01M 4/525; H01M 4/505; H01M 4/587; H01M 2/16

(52) U.S. Cl. CPC H01M 10/0525; H01M 4/525; H01M 2004/021; H01M 4/587; H01M 2/166; H01M 4/505

(57) ABSTRACT

A nonaqueous electrolyte secondary battery, including: a nonaqueous electrolyte secondary battery separator having a capacitance of not less than 0.0145 nF and not more than 0.0230 nF per measurement area of 19.6 mm²; a positive electrode plate having a capacitance of not less than 1 nF and not more than 1000 nF per measurement area of 900 mm²; and a negative electrode plate having a capacitance of not less than 4 nF and not more than 8500 nF per measurement area of 900 mm², is excellent in discharge output characteristic.

This Nonprovisional application claims priority under 35 U.S.C. § 119 on Patent Application No. 2017-105074 filed in Japan on May 26, 2017, the entire contents of which are hereby incorporated by reference.

### TECHNICAL FIELD

The present invention relates to a nonaqueous electrolyte secondary battery. The present invention further relates to a positive electrode, a negative electrode, and a member for a nonaqueous electrolyte secondary battery, each of which is included in the nonaqueous electrolyte secondary battery.

### BACKGROUND ART

Nonaqueous electrolyte secondary batteries, particularly lithium-ion secondary batteries, have a high energy density, and are therefore in wide use as batteries for a personal computer, a mobile telephone, a portable information terminal, and the like. Such nonaqueous electrolyte secondary batteries have recently been developed as on-vehicle batteries.

Safety of a nonaqueous electrolyte secondary battery, typified by a lithium-ion secondary battery, is typically ensured by imparting, to the nonaqueous electrolyte secondary battery, a shutdown function, that is, a function of, in a case where abnormal heat generation occurs, preventing further heat generation by precluding passage of ions between a positive electrode and a negative electrode with use of a separator made of a material which melts in a case where heat generation occurs.

As a nonaqueous electrolyte secondary battery having such a shutdown function, a nonaqueous electrolyte secondary battery has been suggested which, for example, includes a laminated separator that is obtained by forming, on a porous base material, an active layer (coating layer) made of a mixture of inorganic fine particles and a binder polymer (Patent Literatures 1 to 3). Furthermore, a nonaqueous electrolyte secondary battery has been also suggested which includes an electrode for a lithium-ion secondary battery on which electrode a porous film that is made of inorganic fine particles and a binding agent (resin) and that can function as a separator is formed (Patent Literature 4).

### CITATION LIST

### Patent Literature

[Patent Literature 1]

Japanese Translation of PCT International Application, Tokuhyo, No. 2008-503049

[Patent Literature 2]

Japanese Patent No. 5460962

[Patent Literature 3]

Japanese Patent No. 5655088

[Patent Literature 4]

Japanese Patent No. 5569515

### SUMMARY OF INVENTION

### Technical Problem

However, there has been a demand that a nonaqueous electrolyte secondary battery, including the above-described conventional laminated separator or the above-described conventional electrode on which a porous film is formed, have an enhanced high-rate characteristic.

### Solution to Problem

The present invention includes a nonaqueous electrolyte secondary battery, a positive electrode plate for a nonaqueous electrolyte secondary battery (hereinafter referred to as a “nonaqueous electrolyte secondary battery positive electrode plate”), a negative electrode plate for a nonaqueous electrolyte secondary battery (hereinafter referred to as a “nonaqueous electrolyte secondary battery negative electrode plate”), or a member for a nonaqueous electrolyte secondary battery (hereinafter referred to as a “nonaqueous electrolyte secondary battery member”), as described below.

A nonaqueous electrolyte secondary battery in accordance with an embodiment of the present invention is a nonaqueous electrolyte secondary battery including: a positive electrode plate; a separator for a nonaqueous electrolyte secondary battery (hereinafter referred to as a “nonaqueous electrolyte secondary battery separator”); and a negative electrode plate, the nonaqueous electrolyte secondary battery separator having a capacitance of not less than 0.0145 nF and not more than 0.0230 nF per measurement area of 19.6 mm², the positive electrode plate having, by itself, a capacitance of not less than 1 nF and not more than 1000 nF per measurement area of 900 mm², the negative electrode plate having, by itself, a capacitance of not less than 4 nF and not more than 8500 nF per measurement area of 900 mm².

The nonaqueous electrolyte secondary battery in accordance with an embodiment of the present invention is preferably arranged such that the positive electrode plate contains a transition metal oxide. The nonaqueous electrolyte secondary battery in accordance with an embodiment of the present invention is preferably arranged such that the negative electrode plate contains graphite.

A nonaqueous electrolyte secondary battery positive electrode plate in accordance with an embodiment of the present invention is a nonaqueous electrolyte secondary battery positive electrode plate having a capacitance of not less than 1 nF and not more than 1000 nF per measurement area of 900 mm².

A nonaqueous electrolyte secondary battery negative electrode plate in accordance with an embodiment of the present invention is a nonaqueous electrolyte secondary battery negative electrode plate having a capacitance of not less than 4 nF and not more than 8500 nF per measurement area of 900 mm².

A nonaqueous electrolyte secondary battery member in accordance with an embodiment of the present invention is a nonaqueous electrolyte secondary battery member including: a positive electrode plate; a nonaqueous electrolyte secondary battery separator; and a negative electrode plate, the positive electrode plate, the nonaqueous electrolyte secondary battery separator, and the negative electrode plate being disposed in this order, the nonaqueous electrolyte secondary battery separator having a capacitance of not less than 0.0145 nF and not more than 0.0230 nF per measurement area of 19.6 mm², the positive electrode plate having, by itself, a capacitance of not less than 1 nF and not more than 1000 nF per measurement area of 900 mm², the negative electrode plate having, by itself, a capacitance of not less than 4 nF and not more than 8500 nF per measurement area of 900 mm².

### Advantageous Effects of Invention

A nonaqueous electrolyte secondary battery in accordance with an embodiment of the present invention has an excellent discharge output characteristic (high-rate characteristic) under a condition that the nonaqueous electrolyte secondary battery discharges a large electric current at a rate of not less than 20 C. Furthermore, each of a positive electrode plate, a negative electrode plate, and a nonaqueous electrolyte secondary battery member in accordance with an embodiment of the present invention allows a nonaqueous electrolyte secondary battery, including the each of the positive electrode plate, the negative electrode plate, and the nonaqueous electrolyte secondary battery member, to have an enhanced discharge output characteristic.

### BRIEF DESCRIPTION OF DRAWINGS

FIG. 1 is a view schematically illustrating a measurement target electrode whose capacitance was to be measured in Examples of the present application.

FIG. 2 is a view schematically illustrating a probe electrode which was used for measurement of the capacitance in Examples of the present application.

### DESCRIPTION OF EMBODIMENTS

The following description will discuss an embodiment of the present invention. Note, however, that the present invention is not limited to the embodiment. The present invention is not limited to arrangements described below, but may be altered in various ways by a skilled person within the scope of the claims. Any embodiment based on a proper combination of technical means disclosed in different embodiments is also encompassed in the technical scope of the present invention. Note that a numerical expression “A to B” herein means “not less than A and not more than B” unless otherwise stated.

### Embodiment 1: Nonaqueous Electrolyte Secondary Battery

A nonaqueous electrolyte secondary battery in accordance with Embodiment 1 of the present invention is a nonaqueous electrolyte secondary battery including: a positive electrode plate; a nonaqueous electrolyte secondary battery separator; and a negative electrode plate, the nonaqueous electrolyte secondary battery separator having a capacitance of not less than 0.0145 nF and not more than 0.0230 nF per measurement area of 19.6 mm², the positive electrode plate having, by itself, a capacitance of not less than 1 nF and not more than 1000 nF per measurement area of 900 mm², the negative electrode plate having, by itself, a capacitance of not less than 4 nF and not more than 8500 nF per measurement area of 900 mm².

The term “measurement area” herein means an area of a portion of a measurement electrode (upper (main) electrode, probe electrode) of an LCR meter which portion is in contact with a measurement target (a porous film, a positive electrode plate, or a negative electrode plate) in a case where a capacitance is measured by a method for measuring a capacitance (later described). Therefore, a value of a capacitance per measurement area of X mm² means a value obtained in a case where a capacitance is measured with use of an LCR meter while a measurement target and a measurement electrode are in contact with each other such that an area of a portion of the measurement electrode which portion is in contact with the measurement target is X mm².

<Capacitance>

In the present invention, a value of the capacitance of the positive electrode plate is a value measured by a method for measuring a capacitance of an electrode plate (later described), that is, a value measured while a measurement electrode (probe electrode) is in contact with a surface of the positive electrode plate which surface is located on a positive electrode mix layer side. The capacitance of the positive electrode plate mainly indicates a polarization state of a positive electrode mix layer of the positive electrode plate.

In the present invention, a value of the capacitance of the negative electrode plate is a value measured by the method for measuring a capacitance of an electrode plate (later described), that is, a value measured while the measurement electrode is in contact with a surface of the negative electrode plate which surface is located on a negative electrode mix layer side. The capacitance of the negative electrode plate mainly indicates a polarization state of a negative electrode mix layer of the negative electrode plate.

In the present invention, a value of the capacitance of the nonaqueous electrolyte secondary battery separator is a value measured by a method for measuring a capacitance of a nonaqueous electrolyte secondary battery separator (later described). The capacitance of the nonaqueous electrolyte secondary battery separator mainly indicates a polarization state of the nonaqueous electrolyte secondary battery separator.

In a case where the nonaqueous electrolyte secondary battery is discharged, cations (for example, Li⁺ in a case of a lithium-ion secondary battery) which are charge carriers are released from the negative electrode plate. The cations thus released pass through the nonaqueous electrolyte secondary battery separator, and are then taken into the positive electrode plate. In so doing, the cations are solvated, by an electrolyte solvent, in the negative electrode plate and a place where the negative electrode plate and the nonaqueous electrolyte secondary battery separator are in contact with each other, and are desolvated in the positive electrode plate and a place where the positive electrode plate and the nonaqueous electrolyte secondary battery separator are in contact with each other.

A degree to which the cations are solvated is dependent on the polarization state of the negative electrode mix layer of the negative electrode plate and the polarization state of the nonaqueous electrolyte secondary battery separator. A degree to which the cations are desolvated is dependent on the polarization state of the nonaqueous electrolyte secondary battery separator and the polarization state of the positive electrode mix layer of the positive electrode plate.

By (i) promoting solvation of the charge carriers in the negative electrode plate and the place where the negative electrode plate and the nonaqueous electrolyte secondary battery separator are in contact with each other and (ii) promoting desolvation of the charge carriers in the positive electrode plate and the place where the positive electrode plate and the nonaqueous electrolyte secondary battery separator are in contact with each other, internal resistance of the nonaqueous electrolyte secondary battery is reduced. This makes it possible to enhance a discharge output characteristic of the nonaqueous electrolyte secondary battery, especially, in a case where a large electric current is discharged, at a rate of not less than 20 C, from the nonaqueous electrolyte secondary battery. Such effects become remarkable in a case where the capacitance of the nonaqueous electrolyte secondary battery separator, the capacitance of the positive electrode plate, and the capacitance of the negative electrode plate are adjusted so as to fall within respective appropriate ranges.

Therefore, by controlling the capacitance of the negative electrode plate to fall within a suitable range, it is possible to appropriately promote the above-described solvation and, accordingly, possible to enhance the discharge output characteristic of the nonaqueous electrolyte secondary battery. Under the circumstances, the negative electrode plate included in the nonaqueous electrolyte secondary battery in accordance with an embodiment of the present invention has a capacitance of not less than 4 nF and not more than 8500 nF, preferably not less than 4 nF and not more than 3000 nF, more preferably not less than 4 nF and not more than 2600 nF, per measurement area of 900 mm². Note that the capacitance can be not less than 100 nF, not less than 200 nF, or not less than 1000 nF.

Specifically, in a case where the negative electrode plate has a capacitance of less than 4 nF per measurement area of 900 mm², polarizability of the negative electrode plate is so low that the negative electrode plate hardly contributes to promotion of the above-described solvation. Therefore, the nonaqueous electrolyte secondary battery including such a negative electrode plate does not have an enhanced output characteristic. In a case where the negative electrode plate has a capacitance of more than 8500 nF per measurement area of 900 mm², the polarizability of the negative electrode plate is so high that compatibility between (i) inner walls of voids in the negative electrode plate and (ii) the cations (for example, Li⁺) becomes excessively high. This prevents movement (release) of the cations (for example, Li⁺) from the negative electrode plate. Therefore, the nonaqueous electrolyte secondary battery including such a negative electrode plate rather has a low output characteristic.

By controlling the capacitance of the positive electrode plate to fall within a suitable range, it is possible to appropriately promote the above-described desolvation and, accordingly, possible to enhance the discharge output characteristic of the nonaqueous electrolyte secondary battery. Under the circumstances, the positive electrode plate included in the nonaqueous electrolyte secondary battery in accordance with an embodiment of the present invention has a capacitance of not less than 1 nF and not more than 1000 nF, preferably not less than 2 nF and not more than 600 nF, more preferably not less than 2 nF and not more than 400 nF, per measurement area of 900 mm². Note that the capacitance can be not less than 3 nF.

Specifically, in a case where the positive electrode plate has a capacitance of less than 1 nF per measurement area of 900 mm², polarizability of the positive electrode plate is so low that the positive electrode plate hardly contributes to the above-described desolvation. Therefore, the nonaqueous electrolyte secondary battery including such a positive electrode plate does not have an enhanced output characteristic. In a case where the positive electrode plate has a capacitance of more than 1000 nF per measurement area of 900 mm², the polarizability of the positive electrode plate is so high that the desolvation is excessively advanced and, accordingly, the electrolyte solvent for the cations to move inside the positive electrode plate is desolvated, and compatibility between (i) inner walls of voids in the positive electrode plate and (ii) the cations (for example, Li⁺) which have been desolvated becomes excessively high. This prevents movement of the cations (for example, Li⁺) inside the positive electrode plate. Therefore, the nonaqueous electrolyte secondary battery including such a positive electrode plate rather has a low output characteristic.

Furthermore, by controlling the capacitance of the nonaqueous electrolyte secondary battery separator to fall within a suitable range, it is possible to appropriately promote both of the above-described solvation and the above-described desolvation and, accordingly, possible to enhance the discharge output characteristic of the nonaqueous electrolyte secondary battery. Under the circumstances, the nonaqueous electrolyte secondary battery separator included in the nonaqueous electrolyte secondary battery in accordance with an embodiment of the present invention has a capacitance of not less than 0.0145 nF and not more than 0.0230 nF, preferably not less than 0.0150 nF and not more than 0.0225 nF, more preferably not less than 0.0155 nF and not more than 0.0220 nF, per measurement area of 19.6 mm².

Specifically, in a case where the nonaqueous electrolyte secondary battery separator has a capacitance of less than 0.0145 nF per measurement area of 19.6 mm², polarizability of the nonaqueous electrolyte secondary battery separator is so low that the nonaqueous electrolyte secondary battery separator hardly contributes to the desolvation. Therefore, the nonaqueous electrolyte secondary battery including such a nonaqueous electrolyte secondary battery separator does not have an enhanced output characteristic. In a case where the nonaqueous electrolyte secondary battery separator has a capacitance of more than 0.0230 nF per measurement area of 19.6 mm², the polarizability of the nonaqueous electrolyte secondary battery separator is so high that compatibility between (i) inner walls of voids in the nonaqueous electrolyte secondary battery separator and (ii) the cations (for example, Li⁺) which have been desolvated becomes excessively high. This prevents movement of the cations (for example, Li⁺) inside the nonaqueous electrolyte secondary battery separator. Therefore, the nonaqueous electrolyte secondary battery including such a nonaqueous electrolyte secondary battery separator rather has a low output characteristic.

<Method for Adjusting Capacitance>

It is possible to control the capacitance of the positive electrode plate per measurement area of 900 mm² by adjusting a surface area of the positive electrode mix layer. Similarly, it is possible to control the capacitance of the negative electrode plate per measurement area of 900 mm² by adjusting a surface area of the negative electrode mix layer. Specifically, by, for example, rubbing a surface of each of the positive electrode mix layer and the negative electrode mix layer with use of an abrasive paper or the like, it is possible to increase the surface area of each of the positive electrode mix layer and the negative electrode mix layer, and ultimately possible to increase the capacitance of each of the positive electrode plate and the negative electrode plate. Alternatively, it is possible to adjust the capacitance of the positive electrode plate per measurement area of 900 mm² by adjusting a relative dielectric constant of a material of which the positive electrode plate is made, and it is possible to control the capacitance of the negative electrode plate per measurement area of 900 mm² by adjusting a relative dielectric constant of a material of which the negative electrode plate is made. The relative dielectric constant can be adjusted by changing shapes of the voids, a porosity, and distribution of the voids of each of the positive electrode plate and the negative electrode plate. The relative dielectric constant can be alternatively controlled by adjusting the material of which each of the positive electrode plate and the negative electrode plate is made.

It is possible to adjust the capacitance of the nonaqueous electrolyte secondary battery separator per measurement area of 19.6 mm² by adjusting a relative dielectric constant of a material of which the nonaqueous electrolyte secondary battery separator is made, a thickness of the nonaqueous electrolyte secondary battery separator, and/or the like. The relative dielectric constant can be adjusted by changing shapes of the voids, a porosity, and distribution of the voids of the nonaqueous electrolyte secondary battery separator. The relative dielectric constant can be alternatively controlled by adjusting the material of which the nonaqueous electrolyte secondary battery separator is made.

<Method for Measuring Capacitance>

(Method for Measuring Capacitance of Nonaqueous Electrolyte Secondary Battery Separator)

According to an embodiment of the present invention, the capacitance of the nonaqueous electrolyte secondary battery separator per measurement area of 19.6 mm² is measured with use of an LCR meter which has a measurement electrode having a diameter φ of 5 mm. Measurement is carried out at a frequency of 1 KHZ, a temperature of 23° C.±1° C., and a humidity of 50% RH±5% RH.

(Method for Measuring Capacitance of Electrode Plate)

According to an embodiment of the present invention, the capacitance of each of the positive electrode plate and the negative electrode plate (hereinafter each also referred to as an electrode plate) per measurement area of 900 mm² is measured with use of an LCR meter. Measurement is carried out at a frequency of 300 KHz while measurement conditions are set as follows: CV: 0.010 V, SPEED: SLOW2, AVG: 8, CABLE: 1 m, OPEN: All, SHORT: All DCBIAS 0.00 V.

In the above measurements, the capacitance of each of the nonaqueous electrolyte secondary battery separator and the electrode plate each of which has not been included in the nonaqueous electrolyte secondary battery is measured. Note that a value of a capacitance is a unique value determined depending on a shape (surface area) of a solid insulating material (the nonaqueous electrolyte secondary battery separator, the electrode plate), a material of which the solid insulating material is made, shapes of voids in the solid insulating material, a porosity of the solid insulating material, distribution of the voids, and the like. Therefore, the value of the capacitance of each of the nonaqueous electrolyte secondary battery separator and the electrode plate each of which has been included in the nonaqueous electrolyte secondary battery is equivalent to that of the capacitance of each of the nonaqueous electrolyte secondary battery separator and the electrode plate each of which has not been included in the nonaqueous electrolyte secondary battery.

Note that the capacitance of each of the positive electrode plate and the negative electrode plate can be measured after (i) the positive electrode plate and the negative electrode plate are included in the nonaqueous electrolyte secondary battery, (ii) the nonaqueous electrolyte secondary battery are charged and discharged, and then (iii) the positive electrode plate and the negative electrode plate are taken out from the nonaqueous electrolyte secondary battery. Specifically, for example, an electrode laminated body (nonaqueous electrolyte secondary battery member) is taken out from an external member of the nonaqueous electrolyte secondary battery, and is dismantled to take out one electrode plate (the positive electrode plate or the negative electrode plate). From the one electrode plate thus taken out, a piece is cut off which has a size similar to that of the electrode plate serving as a measurement target in the above-described method for measuring a capacitance of an electrode plate. Subsequently, a test piece thus obtained is cleaned several times (for example, three times) in diethyl carbonate (DEC). The cleaning is a step of removing an electrolyte, a product of decomposition of the electrolyte, a lithium salt, and the like, each adhering to a surface of the test piece, by (i) putting and cleaning the test piece in the DEC and then (ii) repeating, several times (for example, three times), a procedure of replacing the DEC with new DEC and cleaning the test piece in the new DEC. The electrode plate which has been cleaned is sufficiently dried, and is then used as a measurement target. A type of the external member of the nonaqueous electrolyte secondary battery, from which external member the electrode laminated body is taken out, is not limited to any particular type. Similarly, a structure of the electrode laminated body, from which the electrode plate is taken out, is not limited to any particular structure.

<Nonaqueous Electrolyte Secondary Battery Separator>

The nonaqueous electrolyte secondary battery separator included in the nonaqueous electrolyte secondary battery in accordance with an embodiment of the present invention can be a nonaqueous electrolyte secondary battery separator which is constituted by a porous film that contains a polyolefin as a main component. Alternatively, the nonaqueous electrolyte secondary battery separator can be a nonaqueous electrolyte secondary battery separator (hereinafter also referred to as a “nonaqueous electrolyte secondary battery laminated separator”) which is obtained by disposing, on the porous film that contains a polyolefin as a main component, an insulating porous layer that contains fine metal oxide particles as a filler. Alternatively, the nonaqueous electrolyte secondary battery separator can be a nonaqueous electrolyte secondary battery separator which is constituted by the insulating porous layer alone.

The nonaqueous electrolyte secondary battery separator included in the nonaqueous electrolyte secondary battery in accordance with an embodiment of the present invention has a thickness of normally 5 μm to 80 μm, preferably 5 μm to 50 μm, particularly preferably 6 μm to 35 μm. In a case where the thickness of the entire separator is less than 5 μm, the separator is easily torn. In a case where the thickness of the entire separator is more than 80 μm, the internal resistance of the nonaqueous electrolyte secondary battery including the separator is increased. This causes a decrease in a battery characteristic such as the output characteristic. Furthermore, in a case where an internal volume of the nonaqueous electrolyte secondary battery is small, there is no choice but to reduce an amount of an electrode and, consequently, a capacity of the nonaqueous electrolyte secondary battery is reduced.

The nonaqueous electrolyte secondary battery separator included in the nonaqueous electrolyte secondary battery in accordance with an embodiment of the present invention has a relative dielectric constant of preferably not less than 1.65 and not more than 2.55, more preferably not less than 1.75 and not more than 2.60, still more preferably not less than 1.80 and not more than 2.60.

By causing the thickness and the relative dielectric constant of the nonaqueous electrolyte secondary battery separator, included in the nonaqueous electrolyte secondary battery in accordance with an embodiment of the present invention, to fall within the respective above-described ranges, it is possible to control the capacitance of the nonaqueous electrolyte secondary battery separator to fall within a suitable range per measurement area of 19.6 mm².

(Nonaqueous Electrolyte Secondary Battery Laminated Separator)

The nonaqueous electrolyte secondary battery laminated separator, which is an example of the nonaqueous electrolyte secondary battery separator included in the nonaqueous electrolyte secondary battery in accordance with an embodiment of the present invention, will be described below.

(Insulating Porous Layer)

The insulating porous layer, which is a member constituting the nonaqueous electrolyte secondary battery laminated separator, can contain fine metal oxide particles and a resin. The insulating porous layer can be the nonaqueous electrolyte secondary battery separator by itself in the form of an electrode coating layer. Alternatively, the insulating porous layer can be a member of the nonaqueous electrolyte secondary battery laminated separator by being disposed on the porous film (later described).

The insulating porous layer used for the nonaqueous electrolyte secondary battery has a thickness (film thickness) of not less than 0.1 μm and not more than 20 μm, preferably not less than 2 μm and not more than 15 μm. In a case where the insulating porous layer is excessively thick (more than 20 μm), the internal resistance of the nonaqueous electrolyte secondary battery including the insulating porous layer is increased. This causes a decrease in the battery characteristic, such as the output characteristic, of the nonaqueous electrolyte secondary battery. In a case where the insulating porous layer is excessively thin (less than 0.1 μm), an insulating property and a withstand voltage leaking property of the insulating porous layer are decreased. Furthermore, in a case where (i) such an insulating porous layer is used as a member of the nonaqueous electrolyte secondary battery laminated separator such that the insulating porous layer is disposed on a polyolefin porous film and (ii) abnormal heat generation occurs in the nonaqueous electrolyte secondary battery including the laminated separator, the insulating porous layer may not be able to withstand thermal shrinkage of the polyolefin porous film, so that the laminated separator may shrink. Note that, in a case where insulating porous layers are formed on respective both surfaces of the porous film (polyolefin porous film), the phrase “the thickness of the insulating porous layer” indicates a total thickness of the insulating porous layers formed on the respective both surfaces of the porous film.

The fine metal oxide particles are made of a metal oxide. The insulating porous layer can contain only one kind of fine metal oxide particles or can alternatively contain two or more kinds of fine metal oxide particles, which kinds are different in particle diameter or specific surface area from each other, in combination.

The fine metal oxide particles each have a shape that varies depending on, for example, (i) a method for producing the metal oxide which is a raw material and (ii) a condition under which the fine metal oxide particles are dispersed during preparation of a coating solution (later described) for forming the insulating porous layer. The fine metal oxide particles can each have any of various shapes such as a spherical shape, an oblong shape, a rectangular shape, a gourd shape, and an indefinite irregular shape.

The fine metal oxide particles are preferably a ground product, more preferably a ground product having an average particle diameter and particle size distribution which fall within respective specific ranges. As a method for obtaining the fine metal oxide particles which are a ground product, there can be a wet grinding method and a dry grinding method. Specific examples of a method for obtaining the ground product include, but are not limited to, a method in which a coarse filler is ground with use of a high-speed rotation mill, a tumbling mill, a vibrating mill, a planetary mill, a medium stirring mill, an airflow crusher, or the like. Of these grinding methods, a dry grinding method in which no dispersion medium is used is preferable, and a dry grinding method in which no dispersion medium is used and a device that employs a grinding medium, such as a bead mill or a vibratory ball mill, is used is more preferable. In addition, the grinding medium particularly preferably has Mohs' hardness equal to or greater than that of the metal oxide. Note that, as a grinding method, a medialess grinding method which does not cause a collision between (i) ceramic particles and (ii) a medium, for example, a method in which grinding is carried out with use of (i) a jet stream and (ii) high-speed shearing by a rotary blade in combination as disclosed in Japanese patent No. 4781263 can be also employed.

The metal oxide of which the fine metal oxide particles are made is not limited to any particular one. Examples of the metal oxide include titanium oxide, alumina, boehmite (alumina monohydrate), zirconia, silica, magnesia, calcium oxide, barium oxide, boron oxide, and zinc oxide. The fine metal oxide particles can be made of only one kind of metal oxide, but are preferably made of two or more kinds of metal oxides in combination. The metal oxide can be a complex oxide. In such a case, the metal oxide preferably contains, as a constituent metal element, at least one element selected from an aluminum element, a titanium element, a zirconium element, a silicon element, a boron element, a magnesium element, a calcium element, and a barium element, more preferably contains an aluminum element and a titanium element, particularly preferably contains a titanium oxide. Furthermore, the fine metal oxide particles preferably contain a solid solution of metal oxides, and are more preferably made solely of a solid solution of metal oxides. Specifically, the fine metal oxide particles are particularly preferably made of a solid solution of alumina and titania.

The resin which can be contained in the insulating porous layer is preferably a resin that is insoluble in the electrolyte of the battery and that is electrochemically stable when the battery is in normal use.

Specific examples of the resin include: polyolefins such as polyethylene, polypropylene, polybutene, and an ethylene-propylene copolymer; fluorine-containing resins such as a homopolymer of vinylidene fluoride (polyvinylidene fluoride), a copolymer of vinylidene fluoride (such as a vinylidene fluoride-hexafluoropropylene copolymer and a vinylidene fluoride-hexafluoropropylene-tetrafluoroethylene copolymer), a copolymer of tetrafluoroethylene (such as ethylene-tetrafluoroethylene copolymer), and any of these fluorine-containing resins which is a fluorine-containing rubber having a glass transition temperature of not higher than 23° C.; aromatic polyamides; fully aromatic polyamides (aramid resins); rubbers such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins each having a melting point or glass transition temperature of not lower than 180° C. such as polyphenylene ether, polysulfone, polyether sulfone, polyphenylene sulfide, polyetherimide, polyamide imide, polyetheramide, and polyester; and water-soluble polymers such as polyvinyl alcohol, polyethyleneglycol, cellulose ether, sodium alginate, polyacrylic acid, polyacrylamide, and polymethacrylic acid.

Of these resins, a polyolefin, a fluorine-containing resin, a fluorine-containing rubber, an aromatic polyamide, or a water-soluble polymer is more preferable. Note that, in a case where the insulating porous layer is used as the separator of the nonaqueous electrolyte secondary battery or in a case where the insulating porous layer is used as the member of the nonaqueous electrolyte secondary battery laminated separator, a fluorine-containing resin is particularly preferable because it is easier to maintain various performance capabilities, such as a rate characteristic and a resistance characteristic (solution resistance), of the nonaqueous electrolyte secondary battery even in a case where deterioration in the separator occurs due to oxidation while the battery is in operation. Note also that a water-soluble polymer is more preferable in view of a process and an environmental load, because it is possible to use water as a solvent for forming the insulating porous layer. As the water-soluble polymer, cellulose ether or sodium alginate is still more preferable, and cellulose ether is particularly preferable.

In a case were the insulating porous layer contains the resin in addition to the fine metal oxide particles, it is preferable that the fine metal oxide particles are in point contact with the resin. This is because, in a case where the insulating porous layer is used as a member of the nonaqueous electrolyte secondary battery or as the member of the nonaqueous electrolyte secondary battery laminated separator, it is possible to further prevent an internal short circuit caused by, for example, breakage of the nonaqueous electrolyte secondary battery.

In a case where the insulating porous layer contains the resin in addition to the fine metal oxide particles, the insulating porous layer contains the fine metal oxide particles in an amount of preferably 1% by volume to 99% by volume, more preferably 5% by volume to 95% by volume, relative to the insulating porous layer.

The insulating porous layer has a porosity of preferably 20% by volume to 90% by volume, more preferably 30% by volume to 70% by volume so that the insulating porous layer can achieve sufficient ion permeability. Pores in the insulating porous layer each have a pore diameter of preferably not more than 3 μm, more preferably not more than 1 μm so that the insulating porous layer can achieve sufficient ion permeability.

The insulating porous layer can be produced by, for example, (i) dissolving the resin in a solvent and dispersing the fine metal oxide particles in the solvent so as to prepare a coating solution for forming the insulating porous layer, (ii) applying the coating solution thus obtained to a base material, and then (iii) removing the solvent so that the insulating porous layer is deposited. Note that the base material can be a porous film (later described) which constitutes the nonaqueous electrolyte secondary battery laminated separator or can be alternatively an electrode plate, particularly, a positive electrode plate included in the nonaqueous electrolyte secondary battery in accordance with an embodiment of the present invention.

The solvent (dispersion medium) is not limited to any particular one, provided that (i) the solvent does not have an adverse effect on the porous film or the electrode plate each serving as the base material, (ii) the solvent allows the resin to be uniformly and stably dissolved in the solvent, and (iii) the solvent allows the fine metal oxide particles to be uniformly and stably dispersed in the solvent. Specific examples of the solvent (dispersion medium) include: water; lower alcohols such as methyl alcohol, ethyl alcohol, n-propyl alcohol, isopropyl alcohol, and t-butyl alcohol; acetone; toluene; xylene; hexane; N-methylpyrrolidone; N,N-dimethylacetamide; and N,N-dimethylformamide. Each of these solvents (dispersion media) can be used solely. Alternatively, two or more of these solvents (dispersion media) can be used in combination.

The coating solution can be formed by any method, provided that the coating solution can meet conditions, such as a resin solid content (resin concentration) and an amount of the fine metal oxide particles, which are necessary to obtain a desired insulating porous layer. Specific examples of a method for forming the coating solution include a mechanical stirring method, an ultrasonic dispersion method, a high-pressure dispersion method, and a media dispersion method. Further, the filler can be dispersed in the solvent (dispersion medium) with use of, for example, a conventionally publicly known dispersing machine such as a three-one motor, a homogenizer, a media dispersing machine, or a pressure dispersing machine. In a case where the fine metal oxide particles are prepared by a wet grinding method, it is possible to prepare the coating solution concurrently with wet grinding for obtaining the fine metal oxide particles having a desired average particle diameter, by supplying, to a wet grinding apparatus during the wet grinding, (i) a liquid in/with which the resin is dissolved or swollen or (ii) an emulsion of the resin. That is, the wet grinding for obtaining the fine metal oxide particles and preparation of the coating solution can be concurrently carried out in a single step. Note that the coating solution can contain, as a component other than the resin and the fine particles, an additive such as a disperser, a plasticizer, a surfactant, and a pH adjustor, provided that the additive does not prevent the object of the present invention from being attained. Note that the additive can be contained in an amount that does not prevent the object of the present invention from being attained.

A method for applying the coating solution to the base material is not limited to any particular one. For example, in a case where the insulating porous layers are disposed on respective both surfaces of the base material, it is possible to employ (i) a sequential disposition method in which an insulating porous layer is formed on one surface of the base material and then another insulating porous layer is formed on the other surface of the base material or (ii) a simultaneous disposition method in which insulating porous layers are simultaneously formed on the respective both surfaces of the base material. Examples of a method for forming the insulating porous layer include: a method in which the coating solution is applied directly to a surface of the base material and then the solvent (dispersion medium) is removed; a method in which (i) the coating solution is applied to an appropriate support, (ii) the solvent (dispersion medium) is removed so that the insulating porous layer is formed, (iii) the insulating porous layer and the base material are bonded together by pressure, and then (iv) the support is peeled off; a method in which (i) the coating solution is applied to an appropriate support, (ii) the base material is bonded to a resultant coated surface by pressure, (iii) the support is peeled off, and then (iv) the solvent (dispersion medium) is removed; and a method in which dip coating is carried out by soaking the base material in the coating solution, and then the solvent (dispersion medium) is removed. The thickness of the insulating porous layer can be controlled by adjusting a thickness of a coating film which is in a wet state (wet) after coating, a weight ratio between the resin and the fine particles, a solid content concentration (a sum of a resin concentration and a fine particle concentration) of the coating solution, and/or the like. Note that the support can be, for example, a resin film, a metal belt, a drum, or the like.

A method for applying the coating solution to the base material or the support is not limited to any particular one, provided that a necessary weight per unit area or a necessary coating area can be realized. As the method for applying the coating solution to the base material or the support, a conventionally publicly known method, such as a knife coater method, a blade coater method, a bar coater method, a gravure coater method, or a die coater method, can be employed.

The solvent (dispersion medium) is generally removed by drying the coating solution. Examples of a method for drying the coating solution include natural drying, air-blowing drying, heat drying, freeze drying, and drying under reduced pressure. Note, however, that any method can be employed, provided that the solvent (dispersion medium) can be sufficiently removed. Note also that the coating solution can be dried after the solvent (dispersion medium) contained in the coating solution is replaced with another solvent. Examples of a method for replacing the solvent (dispersion medium) with another solvent and then removing the another solvent includes a method in which the solvent contained in the coating solution is replaced with a solvent having a low boiling point, such as water, alcohol, or acetone, and then the coating solution is dried.

In a case where the insulating porous layer is disposed on the porous film (later described) so as to form the nonaqueous electrolyte secondary battery laminated separator, the insulating porous layer has a capacitance of preferably not less than 0.0390 nF and not more than 0.142 nF, more preferably not less than 0.0440 nF and not more than 0.140 nF, still more preferably not less than 0.0440 nF and not more than 0.135 nF, per measurement area of 19.6 mm².

(Porous Film)

The porous film which contains a polyolefin as a main component (hereinafter also referred to as a “polyolefin porous film”) has therein many pores, connected to one another, so that a gas and/or a liquid can pass through the porous film from one side to the other side.

The polyolefin contained in the porous film as a main component accounts for not less than 50% by volume, more preferably not less than 90% by volume, still more preferably not less than 95% by volume of the entire porous film. The polyolefin more preferably contains a high molecular weight component having a weight-average molecular weight of 5×10⁵ to 15×10⁶. In particular, the polyolefin more preferably contains a high molecular weight component having a weight-average molecular weight of not less than 1,000,000, because the porous film and a laminated body including the porous film, that is, the nonaqueous electrolyte secondary battery laminated separator each have higher strength.

Specific examples of the polyolefin, which is a thermoplastic resin, include homopolymers (for example, polyethylene, polypropylene, and polybutene) and copolymers (for example, an ethylene-propylene copolymer) each of which homopolymers and copolymers is produced through (co)polymerization of a monomer(s) such as ethylene, propylene, 1-butene, 4-methyl-1-pentene, and/or 1-hexene. Of these polyolefins, polyethylene is more preferable because it is possible to prevent (shut down) a flow of an excessively large electric current at a lower temperature. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Of these polyethylenes, ultra-high molecular weight polyethylene having a weight-average molecular weight of not less than 1,000,000 is still more preferable.

The porous film has a thickness of typically 4 μm to 50 μm, preferably 5 μm to 30 μm. In a case where the thickness of the porous film is less than 4 μm, the porous film has insufficient mechanical strength. This may cause the porous film to be torn during assembly of the battery. Furthermore, in such a case, since the porous film retains the electrolyte in a decreased amount, a battery long-term characteristic of the nonaqueous electrolyte secondary battery including the porous film is decreased. In a case where the thickness of the porous film is more than 50 μm, the porous film has increased resistance to permeation of the charge carriers such as lithium ions. Therefore, a rate characteristic or a cycle characteristic of the nonaqueous electrolyte secondary battery is decreased.

In a case where the insulating porous layer is disposed on the porous film so as to form the nonaqueous electrolyte secondary battery laminated separator, the porous film has a capacitance of preferably not less than 0.0230 nF and not more than 0.0270 nF, more preferably not less than 0.0235 nF and not more than 0.0270 nF, per measurement area of 19.6 mm².

Note, here, that, by controlling the capacitance of the insulating porous layer and the capacitance of the porous film to fall within the respective above-described ranges per measurement area of 19.6 mm², it is possible to adjust the capacitance of the nonaqueous electrolyte secondary battery laminated separator, which is constituted by the insulating porous layer and the porous film, to a range of not less than 0.0145 nF and not more than 0.0230 nF per measurement area of 19.6 mm².

The porous film has a porosity of preferably 30% by volume to 60% by volume, and more preferably 35% by volume to 55% by volume, so as to (i) retain the electrolyte in a larger amount and (ii) obtain a function of absolutely preventing (shutting down) a flow of an excessively large electric current at a lower temperature.

In a case where the porosity of the porous film is less than 30% by volume, the porous film has an increased resistance. In a case where the porosity of the porous film is more than 60% by volume, the porous film has decreased mechanical strength.

The pores in the porous film each have a pore diameter of preferably not more than 3 μm, more preferably not more than 1 μm so that (i) the nonaqueous electrolyte secondary battery separator can achieve sufficient ion permeability and (ii) particles constituting the positive electrode plate or the negative electrode plate can be prevented from entering the porous film.

A method for producing the porous film is not limited to any particular one. For example, the porous film can be produced by (i) adding a plasticizer to a resin such as a polyolefin, (ii) a resultant mixture is formed into a film, and (iii) the plasticizer is removed with use of an appropriate solvent.

Specifically, for example, in a case where the porous film is produced with use of a polyolefin resin containing ultra-high molecular weight polyethylene and a low molecular weight polyolefin which has a weight-average molecular weight of not more than 10,000, it is preferable to, from the viewpoint of production costs, produce the porous film by a method including the following steps:

(1) obtaining a polyolefin resin composition by kneading (i) 100 parts by weight of ultra-high molecular weight polyethylene, (ii) 5 parts by weight to 200 parts by weight of a low molecular weight polyolefin having a weight-average molecular weight of not more than 10,000, and (iii) 100 parts by weight to 400 parts by weight of an inorganic filler such as calcium carbonate;
(2) forming a sheet with use of the polyolefin resin composition;
(3) removing the inorganic filler from the sheet obtained in the step (2); and
(4) obtaining a porous film by stretching the sheet from which the inorganic filler has been removed in the step (3); or
(3′) stretching the sheet obtained in the step (2); and
(4′) obtaining a porous film by removing the inorganic filler from the sheet which has been stretched in the step (3′).

(Method for Producing Nonaqueous Electrolyte Secondary Battery Laminated Separator)

The nonaqueous electrolyte secondary battery laminated separator in accordance with an embodiment of the present invention can be produced by using the above-described porous film as the base material in the above-described method for producing the insulating porous layer.

<Positive Electrode Plate>

The positive electrode plate included in the nonaqueous electrolyte secondary battery in accordance with an embodiment of the present invention is not limited to any particular one, provided that the positive electrode plate has a capacitance falling within the above-described range per measurement area of 900 mm². For example, the positive electrode plate is a sheet-shaped positive electrode plate including (i) a positive electrode mix containing a positive electrode active material, an electrically conductive agent, and a binding agent and (ii) a positive electrode current collector supporting the positive electrode mix thereon. Note that the positive electrode plate can be arranged such that the positive electrode current collector supports positive electrode mixes on respective both surfaces of the positive electrode current collector or can be alternatively arranged such that the positive electrode current collector supports the positive electrode mix on one surface of the positive electrode current collector.

Examples of the positive electrode active material include materials each capable of being doped with and dedoped of lithium ions. Specifically, of the materials, a transition metal oxide is preferable. Examples of the transition metal oxide include lithium complex oxides each containing at least one transition metal such as V, Mn, Fe, Co, or Ni. Of the lithium complex oxides, (i) a lithium complex oxide having an α-NaFeO₂ structure, such as lithium nickelate and lithium cobaltate, and (ii) a lithium complex oxide having a spinel structure, such as lithium manganese spinel, are more preferable, because such lithium complex oxides each have a high average discharge potential. The lithium complex oxides each containing at least one transition metal may each further contain any of various metal elements, and complex lithium nickelate is still more preferable.

Further, the complex lithium nickelate particularly preferably contains at least one metal element selected from the group consisting of Ti, Zr, Ce, Y, V, Cr, Mn, Fe, Co, Cu, Ag, Mg, Al, Ga, In, and Sn at a proportion of 0.1 mol % to 20 mol % with respect to a sum of the number of moles of the at least one metal element and the number of moles of Ni in lithium nickelate. This is because such a complex lithium nickelate allows an excellent cycle characteristic in a case where it is used in a high-capacity battery.

Examples of the electrically conductive agent include carbonaceous materials such as natural graphite, artificial graphite, cokes, carbon black, pyrolytic carbons, carbon fiber, and a fired product of an organic polymer compound. Each of these electrically conductive agents can be used solely. Alternatively, two or more of these electrically conductive agents (for example, artificial graphite and carbon black) can be used in combination.

Examples of the binding agent include: thermoplastic resins such as polyvinylidene fluoride, a copolymer of vinylidene fluoride, polytetrafluoroethylene, a tetrafluoroethylene-hexafluoropropylene copolymer, a tetrafluoroethylene-perfluoroalkyl vinyl ether copolymer, an ethylene-tetraflu or oethylene copolymer, a vinylidene fluoride-hexafluoropropylene copolymer, a vinylidene fluoride-hexafluoropropylene-tetrafluoroethylene copolymer, a thermoplastic polyimide, polyethylene, and polypropylene; an acrylic resin; and styrene-butadiene-rubber. Note that the binding agent functions also as a thickener.

Examples of a method for obtaining the positive electrode mix include: a method in which the positive electrode active material, the electrically conductive agent, and the binding agent are pressured on the positive electrode current collector; and a method in which the positive electrode active material, the electrically conductive agent, and the binding agent are formed into a paste with use of an appropriate organic solvent.

Examples of the positive electrode current collector include electric conductors such as Al, Ni, and stainless steel. Of these electric conductors, Al is more preferable because Al is easily processed into a thin film and is inexpensive.

Examples of a method for producing the sheet-shaped positive electrode plate, i.e., a method for causing the positive electrode current collector to support the positive electrode mix include: a method in which the positive electrode active material, the electrically conductive agent, and the binding agent which constitute the positive electrode mix are pressure-molded on the positive electrode current collector; and a method in which (i) the positive electrode mix is obtained by forming the positive electrode active material, the electrically conductive agent, and the binding agent into a paste with use of an appropriate organic solvent, (ii) the positive electrode current collector is coated with the positive electrode mix, and then (iii) a sheet-shaped positive electrode mix obtained by drying the positive electrode mix is pressed on the positive electrode current collector so that the sheet-shaped positive electrode mix is firmly fixed to the positive electrode current collector.

<Negative Electrode Plate>

The negative electrode plate included in the nonaqueous electrolyte secondary battery in accordance with an embodiment of the present invention is not limited to any particular one, provided that the negative electrode plate has a capacitance falling within the above-described range per measurement area of 900 mm². For example, the negative electrode plate is a sheet-shaped negative electrode plate including (i) a negative electrode mix containing a negative electrode active material and (ii) a negative electrode current collector supporting the negative electrode mix thereon. The sheet-shaped negative electrode plate preferably contains an electrically conductive agent as described above and a binding agent as described above. Note that the negative electrode plate can be arranged such that the negative electrode current collector supports negative electrode mixes on respective both surfaces of the negative electrode current collector or can be alternatively arranged such that the negative electrode current collector supports the negative electrode mix on one surface of the negative electrode current collector.

Examples of the negative electrode active material include: materials each capable of being doped with and dedoped of lithium ions; lithium metal; and lithium alloy. Specific examples of the materials include: carbonaceous materials such as natural graphite, artificial graphite, cokes, carbon black, pyrolytic carbons, carbon fiber, and a fired product of an organic polymer compound; and chalcogen compounds, such as an oxide and a sulfide, each of which is doped with and dedoped of lithium ions at an electric potential lower than that for the positive electrode plate. Of these negative electrode active materials, a carbonaceous material containing graphite is preferable, and a carbonaceous material containing a graphite material, such as natural graphite or artificial graphite, as a main component is more preferable, because such carbonaceous materials each have high electric potential flatness and low average discharge potential and, therefore, achieve high energy density when combined with the positive electrode plate. Further, the negative electrode active material can be a carbonaceous material containing graphite as a main component and further containing silicon.

Examples of a method for obtaining the negative electrode mix include: a method in which the negative electrode active material is pressured on the negative electrode current collector; and a method in which the negative electrode active material is formed into a paste with use of an appropriate organic solvent.

Examples of the negative electrode current collector include electric conductors such as Cu, Ni, and stainless steel. Of these electric conductors, Cu is more preferable because Cu is not easily alloyed with lithium particularly in a lithium-ion secondary battery and is easily processed into a thin film.

Examples of a method for producing the sheet-shaped negative electrode plate, i.e., a method for causing the negative electrode current collector to support the negative electrode mix include: a method in which the negative electrode active material which constitutes the negative electrode mix is pressure-molded on the negative electrode current collector; and a method in which (i) the negative electrode mix is obtained by forming the negative electrode active material into a paste with use of an appropriate organic solvent, (ii) the negative electrode current collector is coated with the negative electrode mix, and then (iii) a sheet-shaped negative electrode mix obtained by drying the negative electrode mix is pressed on the negative electrode current collector so that the sheet-shaped negative electrode mix is firmly fixed to the negative electrode current collector. The paste preferably contains an electrically conductive agent as described above and a binding agent as described above.

<Nonaqueous Electrolyte>

The nonaqueous electrolyte which can be contained in the nonaqueous electrolyte secondary battery in accordance with an embodiment of the present invention can be a nonaqueous electrolyte prepared by, for example, dissolving a lithium salt in an organic solvent which is an electrolyte solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. Each of these lithium salts can be used solely. Alternatively, two or more of these lithium salts can be used in combination. Of these lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃ is more preferable.

The electrolyte solvent is not limited to any particular one. Specific examples of the electrolyte solvent include: carbonates such as ethylene carbonate (EC), propylene carbonate (PMC), dimethyl carbonate (DMC), diethyl carbonate (DEC), ethyl methyl carbonate (EMC), 4-trifluoromethyl-1,3-dioxolane-2-one, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into an organic solvent as described above. Each of these electrolyte solvents can be used solely. Alternatively, two or more of these electrolyte solvents can be used in combination. Of these electrolyte solvents, a carbonate is more preferable, and a mixed solvent of a cyclic carbonate and an acyclic carbonate or a mixed solvent of a cyclic carbonate and an ether is still more preferable. As the mixed solvent of a cyclic carbonate and an acyclic carbonate, a mixed solvent of ethylene carbonate, dimethyl carbonate, and ethyl methyl carbonate is still more preferable, because such a mixed solvent allows a wider operating temperature range and is not easily decomposed even in a case where a graphite material such as natural graphite or artificial graphite is used as the negative electrode active material.

<Method for Producing Nonaqueous Electrolyte Secondary Battery>

The nonaqueous electrolyte secondary battery in accordance with an embodiment of the present invention can be produced by, for example, (i) forming the nonaqueous electrolyte secondary battery member by disposing the positive electrode plate, the nonaqueous electrolyte secondary battery separator, and the negative electrode plate in this order, (ii) placing the nonaqueous electrolyte secondary battery member in a container which is to serve as a housing of the nonaqueous electrolyte secondary battery, (iii) filling the container with the nonaqueous electrolyte, and then (iv) hermetically sealing the container while reducing pressure inside the container. A shape of the nonaqueous electrolyte secondary battery is not limited to any particular one. The nonaqueous electrolyte secondary battery can have any shape such as a shape of a thin plate (sheet), a disk, a cylinder, or a prism such as a cuboid. Note that a method for producing the nonaqueous electrolyte secondary battery in accordance with an embodiment of the present invention is not limited to any particular one, and a conventionally publicly known method can be employed.

### Embodiment 2: Nonaqueous Electrolyte Secondary Battery Positive Electrode Plate

A nonaqueous electrolyte secondary battery positive electrode plate in accordance with Embodiment 2 of the present invention is a nonaqueous electrolyte secondary battery positive electrode plate having, by itself, a capacitance of not less than 1 nF and not more than 1000 nF per measurement area of 900 mm².

Since the nonaqueous electrolyte secondary battery positive electrode plate in accordance with an embodiment of the present invention has a capacitance falling within the above-described range, it is possible for a nonaqueous electrolyte secondary battery, including the nonaqueous electrolyte secondary battery positive electrode plate, to have an enhanced discharge output characteristic.

The nonaqueous electrolyte secondary battery positive electrode plate in accordance with an embodiment of the present invention is identical to the positive electrode plate which constitutes the nonaqueous electrolyte secondary battery in accordance with Embodiment 1 of the present invention. Therefore, the nonaqueous electrolyte secondary battery positive electrode plate will not be described here.

### Embodiment 3: Nonaqueous Electrolyte Secondary Battery Negative Electrode Plate

A nonaqueous electrolyte secondary battery negative electrode plate in accordance with Embodiment 3 of the present invention is a nonaqueous electrolyte secondary battery negative electrode plate having a capacitance of not less than 4 nF and not more than 8500 nF per measurement area of 900 mm².

Since the nonaqueous electrolyte secondary battery negative electrode plate in accordance with an embodiment of the present invention has a capacitance falling within the above-described range, it is possible for a nonaqueous electrolyte secondary battery, including the nonaqueous electrolyte secondary battery negative electrode plate, to have an enhanced discharge output characteristic.

The nonaqueous electrolyte secondary battery negative electrode plate in accordance with an embodiment of the present invention is identical to the negative electrode plate which constitutes the nonaqueous electrolyte secondary battery in accordance with Embodiment 1 of the present invention. Therefore, the nonaqueous electrolyte secondary battery negative electrode plate will not be described here.

### Embodiment 4: Nonaqueous Electrolyte Secondary Battery Member

A nonaqueous electrolyte secondary battery member in accordance with Embodiment 4 of the present invention is a nonaqueous electrolyte secondary battery member including: a positive electrode plate; a nonaqueous electrolyte secondary battery separator; and a negative electrode plate, the positive electrode plate, the nonaqueous electrolyte secondary battery separator, and the negative electrode plate being disposed in this order, the nonaqueous electrolyte secondary battery separator having a capacitance of not less than 0.0145 nF and not more than 0.0230 nF per measurement area of 19.6 mm², the positive electrode plate having, by itself, a capacitance of not less than 1 nF and not more than 1000 nF per measurement area of 900 mm², the negative electrode plate having, by itself, a capacitance of not less than 4 nF and not more than 8500 nF per measurement area of 900 mm².

Since the nonaqueous electrolyte secondary battery member in accordance with an embodiment of the present invention includes the positive electrode plate, the negative electrode plate, and the nonaqueous electrolyte secondary battery separator, which have respective capacitances falling within the respective above-described ranges, it is possible for a nonaqueous electrolyte secondary battery, including the nonaqueous electrolyte secondary battery member, to have an enhanced discharge output characteristic.

The nonaqueous electrolyte secondary battery member in accordance with an embodiment of the present invention is identical to the nonaqueous electrolyte secondary battery member which is a member of the nonaqueous electrolyte secondary battery in accordance with Embodiment 1 of the present invention. Further, the positive electrode plate, the negative electrode plate, and the nonaqueous electrolyte secondary battery separator which constitute the nonaqueous electrolyte secondary battery member in accordance with an embodiment of the present invention are also identical to the positive electrode plate, the negative electrode plate, and the nonaqueous electrolyte secondary battery separator, respectively, which are members of the nonaqueous electrolyte secondary battery in accordance with Embodiment 1 of the present invention. Therefore, the nonaqueous electrolyte secondary battery member will not be described here.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### EXAMPLES

The present invention will be described below in more detail with reference to Examples and Comparative Examples. Note, however, that the present invention is not limited to those Examples.

[Measurement Methods]

Physical properties of a nonaqueous electrolyte secondary battery separator, a positive electrode plate, and a negative electrode plate prepared in each of Examples and Comparative Examples were measured by methods below. Furthermore, a discharge output characteristic (high-rate characteristic) of a nonaqueous electrolyte secondary battery prepared in each of Examples and Comparative Examples was measured by a method below.

(1) Film Thickness (Unit: μm)

A film thickness of a nonaqueous electrolyte secondary battery separator and thicknesses of a positive electrode plate and a negative electrode plate were measured with use of a high-precision digital length measuring machine (VL-50) manufactured by Mitutoyo Corporation.

(2) Measurement of Capacitance of Nonaqueous Electrolyte Secondary Battery Separator

A capacitance of a nonaqueous electrolyte secondary battery separator per measurement area of 19.6 mm², which nonaqueous electrolyte secondary battery separator was obtained in each of Examples and Comparative Examples, was measured with use of a precision LCR meter (model number: E4980A) manufactured by Agilent Technologies Japan, Ltd. In so doing, an electrode (φ=5 mm) having a micrometer and a guarded electrode was used as an upper (main) electrode, and an electrode (φ=30 mm) was used as a lower (counter) electrode. Specifically, the nonaqueous electrolyte secondary battery separator was placed on the lower electrode, and the upper electrode was placed on the nonaqueous electrolyte secondary battery separator. Thereafter, measurement was carried out at a frequency of 1 KHz, a temperature of 23° C.±1° C., and a humidity of 50% RH±5% RH. Note that an area (19.6 mm²) of the upper (main) electrode having a diameter φ of 5 mm is a measurement area.

(3) Measurement of Capacitance of Electrode Plate

A capacitance of each of a positive electrode plate and a negative electrode plate per measurement area of 900 mm², which positive electrode plate and negative electrode plate were obtained in each of Examples and Comparative Examples, was measured with use of an LCR meter (model number: IM3536) manufactured by HIOKI E.E. CORPORATION. Measurement was carried out at a frequency of 300 KHz while measurement conditions were set as follows: CV: 0.010 V, SPEED: SLOW2, AVG: 8, CABLE: 1 m, OPEN: All, SHORT: All DCBIAS 0.00 V. An absolute value of the capacitance thus measured was regarded as a capacitance in Examples and Comparative Examples.

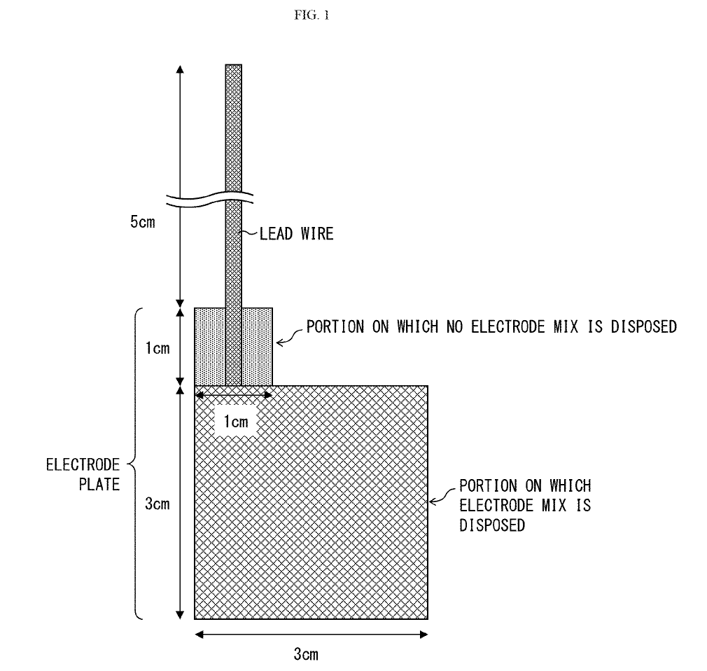

From an electrode plate which was a measurement target, a single piece was cut off so that the single piece had (i) a first portion which had a 3 cm×3 cm square shape and on which an electrode mix was disposed and (ii) a second portion which had a 1 cm×1 cm square shape and on which no electrode mix was disposed. To the second portion of the single piece thus cut off from the electrode plate, a lead wire, having a length of 6 cm and a width of 0.5 cm, was ultrasonically welded to obtain an electrode plate whose capacitance was to be measured (FIG. 1). An aluminum lead wire was used for the positive electrode plate, and a nickel lead wire was used for the negative electrode plate.

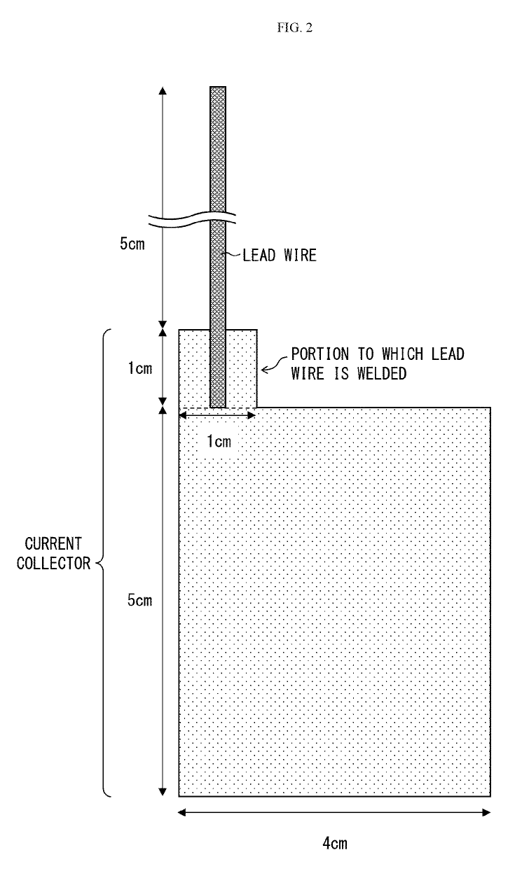

From a current collector, a single piece was cut off so that the single piece had (i) a first portion which had a 5 cm×4 cm rectangular shape and (ii) a second portion which had a 1 cm×1 cm square shape and to which a lead wire was to be welded. To the second portion of the single piece thus cut off from the current collector, a lead wire, having a length of 6 cm and a width of 0.5 cm, was ultrasonically welded to obtain a probe electrode (measurement electrode) (FIG. 2). An aluminum probe electrode having a thickness of 20 μm was used to measure the capacitance of the positive electrode plate, and a copper probe electrode having a thickness of 20 μm was used to measure the capacitance of the negative electrode plate.

The probe electrode was laid over the first portion (portion having a 3 cm×3 cm square shape) of the electrode plate, whose capacitance was to be measured, to prepare a laminated body. The laminated body thus obtained was sandwiched between two sheets of silicon rubber. A resultant laminated body was further sandwiched between two SUS plates with a pressure of 0.7 MPa to obtain a laminated body which was to be subjected to the measurement. The lead wire of the electrode plate, whose capacitance was to be measured, and the lead wire of the probe electrode were drawn outside the laminated body which was to be subjected to the measurement. Each of a voltage terminal and an electric current terminal of the LCR meter was connected to those lead wires so that the voltage terminal was closer to the electrode plate than the electric current terminal.

(4) Measurement of Porosity of Positive Electrode Mix Layer

A porosity of a positive electrode mix layer included in a positive electrode plate in Example 1 below was measured by a method below. A porosity of a positive electrode mix layer included in each of the other positive electrode plates in the other Examples below was also measured by a similar method.

A positive electrode plate, arranged such that a positive electrode mix (a mixture of LiNi_{0.5}Mn_{0.3}Co_{0.2}O₂, an electrically conductive agent, and PVDF (at a weight ratio of 92:5:3)) was disposed on one surface of a positive electrode current collector (aluminum foil), was cut to obtain a piece having a size of 14.5 cm² (4.5 cm×3 cm+1 cm×1 cm). A resultant cut piece of the positive electrode plate had a mass of 0.215 g and had a thickness of 58 μm. The positive electrode current collector was cut to obtain a piece having the same size as the cut piece of the positive electrode plate. A resultant cut piece of the positive electrode current collector had a mass of 0.078 g and had a thickness of 20 μm.

A density ρ of such a positive electrode mix layer was calculated as (0.215−0.078)/{(58−20)/10000×14.5}=2.5 g/cm³.

Each of materials contained in the positive electrode mix had a real density as follows: the LiNi_{0.5}Mn_{0.3}Co_{0.2}O₂, the electrically conductive agent, and the PVDF had real densities of 4.68 g/cm³, 1.8 g/cm³, and 1.8 g/cm³, respectively.

The positive electrode mix layer had a porosity °ε of 40%, which was calculated from the above values by the following expression:

°ε=[1−{2.5×(92/100)/4.68+2.5×(5/100)/1.8+2.5×(3/100)/1.8}]×100=40%

(5) Measurement of Porosity of Negative Electrode Mix Layer

A porosity of a negative electrode mix layer included in a negative electrode plate in Example 1 below was measured by a method below. A porosity of a negative electrode mix layer included in each of the other negative electrode plates in the other Examples below was also measured by a similar method.

A negative electrode plate, arranged such that a negative electrode mix (a mixture of graphite, a styrene-1,3-butadiene copolymer, and sodium carboxymethyl cellulose (at a weight ratio of 98:1:1)) was disposed on one surface of a negative electrode current collector (copper foil), was cut to obtain a piece having a size of 18.5 cm² (5 cm×3.5 cm+1 cm×1 cm). A resultant cut piece of the negative electrode plate had a mass of 0.266 g and had a thickness of 48 μm. The negative electrode current collector was cut to obtain a piece having the same size as the cut piece of the negative electrode plate. A resultant cut piece of the negative electrode current collector had a mass of 0.162 g and had a thickness of 10 μm.

A density ρ of such a negative electrode mix layer was calculated as (0.266−0.162)/{(48−10)/10000×18.5}=1.49 g/cm³.

Each of materials contained in the negative electrode mix had a real density as follows: the graphite, the styrene-1,3-butadiene copolymer, and the sodium carboxymethyl cellulose had real densities of 2.2 g/cm³, 1 g/cm³, and 1.6 g/cm³, respectively.

The negative electrode mix layer had a porosity °ε of 31%, which was calculated from the above values by the following expression:

°ε=[1−{1.49×(98/100)/2.2+1.49×(1/100)/1+1.49×(1/100)/1.6}]×100=31%

(6) High-Rate Characteristic (mAh) of Nonaqueous Electrolyte Secondary Battery:

A nonaqueous electrolyte secondary battery prepared in each of Examples and Comparative Examples was subjected to 4 initial charge-discharge cycles. Each of the 4 initial charge-discharge cycles was carried out at a temperature of 25° C., at a voltage ranging from 2.7 V to 4.1 V, and with an electric current at a rate of 0.2 C. Note that 1 C is defined as a value of an electric current with which a rated capacity based on a discharge capacity at 1 hour rate is discharged in 1 hour. The same applies to the following description.

After the 4 initial charge-discharge cycles, the nonaqueous electrolyte secondary battery was subjected to 3 charge-discharge cycles. Each of the 3 charge-discharge cycles was carried out at a temperature of 55° C. under conditions that (i) the nonaqueous electrolyte secondary battery was charged with a constant electric current at a rate of 1 C and (ii) the nonaqueous electrolyte secondary battery discharged a constant electric current at a rate of 20 C. A discharge capacity in each charge-discharge cycle was then measured.

The discharge capacity in the third charge-discharge cycle, in which a value of the constant discharge electric current was 20 C, was regarded as a measured discharge capacity at measurement of a high-rate characteristic.

### Example 1

<Preparation of Nonaqueous Electrolyte Secondary Battery Separator>

(Preparation of a Layer)

A porous film which was to serve as a base material was prepared with use of polyethylene which was a polyolefin. Specifically, 70 parts by weight of an ultra-high molecular weight polyethylene powder (340M, produced by Mitsui Chemicals, Inc.) and 30 parts by weight of polyethylene wax having a weight-average molecular weight of 1000 (FNP-0115, produced by Nippon Seiro Co., Ltd.) were mixed together to obtain mixed polyethylene. To 100 parts by weight of the mixed polyethylene thus obtained, 0.4 parts by weight of an antioxidant (Irg1010, produced by CIBA Specialty Chemicals Inc.), 0.1 parts by weight of another antioxidant (P168, produced by CIBA Specialty Chemicals Inc.), and 1.3 parts by weight of sodium stearate were added. Subsequently, calcium carbonate having an average particle diameter of 0.1 μm (produced by Maruo Calcium Co., Ltd.) was further added so that the calcium carbonate accounted for 38% by volume of a total volume. A resultant composition was mixed in a Henschel mixer in the form of a powder, and was then melted and kneaded in a twin screw kneading extruder to obtain a polyethylene resin composition. Next, the polyethylene resin composition was rolled with use of a pair of rollers, each having a surface temperature set at 150° C., to prepare a sheet. The sheet was immersed in an aqueous hydrochloric acid solution (which contained 4 mol/L of hydrochloric acid and 0.5% by weight of a nonionic surfactant) so that the calcium carbonate was dissolved for removal. Thereafter, the sheet was stretched at 105° C. so that the sheet had an area 6 times an original area. A porous film made of polyethylene (A layer) was thus prepared.

(Preparation of B Layer)

(Production of Fine Metal Oxide Particles)

Aluminiumoxid/Titandioxid (Al₂O₃:TiO₂=99:1, solid solution), produced by Ceram GmbH, was used as a metal oxide. The metal oxide was ground for 4 hours in a vibrating mill, provided with an alumina pot having a capacity of 3.3 L and an alumina ball having a diameter φ of 15 mm, to obtain fine metal oxide particles.

(Production of Coating Solution)

The fine metal oxide particles, a vinylidene fluoride-hexafluoropropylene copolymer (product name “KYNAR2801”, produced by Arkema Inc.) serving as a binder resin, and N-methyl-2-pyrrolidinone (produced by Kanto Chemical Co., Inc.) serving as a solvent were mixed together as follows:

First, 10 parts by weight of the vinylidene fluoride-hexafluoropropylene copolymer was added to 90 parts by weight of the fine metal oxide particles to obtain a mixture. The solvent was added to the mixture thus obtained so that a solid content (that is, the fine metal oxide particles and the vinylidene fluoride-hexafluoropropylene copolymer) had a concentration of 40% by weight. A mixed solution was thus obtained. The mixed solution thus obtained was stirred and mixed in a thin-film rotary high-speed mixer (FILMIX (registered trademark), produced by PRIMIX Corporation) to obtain a uniform coating solution 1.

(Preparation of Nonaqueous Electrolyte Secondary Battery Separator (Laminated Separator))

One surface of the A layer was coated with the coating solution 1 by a doctor blade method. A resultant coating film was dried at 85° C. with use of an air blowing dryer (model: WFO-601SD, produced by Tokyo Rikakikai Co., Ltd.). Consequently, a B layer was obtained. After such drying, the B layer was pressed. As a result, a laminated porous film 1, including (i) the A layer and (ii) the B layer disposed on one surface of the A layer, was obtained. The laminated porous film 1 was employed as a nonaqueous electrolyte secondary battery separator 1. The nonaqueous electrolyte secondary battery separator 1 had a film thickness of 18.5 μm.

<Preparation of Positive Electrode Plate>

A positive electrode plate was obtained which was arranged such that a positive electrode mix (a mixture of LiNi_{0.5}Mn_{0.3}Co_{0.2}O₂, an electrically conductive agent, and PVDF (at a weight ratio of 92:5:3)) was disposed on one surface of a positive electrode current collector (aluminum foil). In the positive electrode plate thus obtained, a positive electrode mix layer had a thickness of 38 μm and a porosity of 40%.

The positive electrode plate was cut so that (i) a first portion of the positive electrode plate, on which first portion the positive electrode mix (layer) was disposed, had a size of 45 mm×30 mm and (ii) a second portion of the positive electrode plate, on which second portion no positive electrode mix (layer) was disposed and which second portion had a width of 13 mm, remained on an outer periphery of the first portion. A resultant positive electrode plate was employed as a positive electrode plate 1.

<Preparation of Negative Electrode Plate>

A negative electrode plate was obtained which was arranged such that a negative electrode mix (a mixture of graphite, a styrene-1,3-butadiene copolymer, and sodium carboxymethyl cellulose (at a weight ratio of 98:1:1)) was disposed on one surface of a negative electrode current collector (copper foil). In the negative electrode plate thus obtained, a negative electrode mix layer had a thickness of 38 μm and a porosity of 31%.

The negative electrode plate was cut so that (i) a first portion of the negative electrode plate, on which first portion the negative electrode mix (layer) was disposed, had a size of 50 mm×35 mm and (ii) a second portion of the negative electrode plate, on which second portion no negative electrode mix (layer) was disposed and which second portion had a width of 13 mm, remained on an outer periphery of the first portion. A resultant negative electrode plate was employed as a negative electrode plate 1.

<Preparation of Nonaqueous Electrolyte Secondary Battery>

The positive electrode plate 1, the nonaqueous electrolyte secondary battery separator 1, and the negative electrode plate 1 were disposed (arranged) in this order in a laminate pouch to obtain a nonaqueous electrolyte secondary battery member 1. In so doing, the positive electrode plate 1 and the negative electrode plate 1 were arranged so that a main surface of the positive electrode mix layer of the positive electrode plate 1 was entirely included in a range of a main surface of the negative electrode mix layer of the negative electrode plate 1 (i.e., entirely covered by the main surface of the negative electrode mix layer of the negative electrode plate 1).

Subsequently, the nonaqueous electrolyte secondary battery member 1 was put into a bag which had been formed by disposing an aluminum layer on a heat seal layer. Further, 0.25 mL of a nonaqueous electrolyte was put into the bag. As the nonaqueous electrolyte, an electrolyte was used which had a temperature of 25° C. and which was prepared by dissolving LiPF₆ in a mixed solvent, in which ethyl methyl carbonate (a relative dielectric constant of 2.9, a temperature of 25° C.), diethyl carbonate (a relative dielectric constant of 2.8, a temperature of 25° C.), and ethylene carbonate (a relative dielectric constant of 89.78, a temperature of 40° C.) were mixed at a volume ratio of 50:20:30, so that the LiPF₆ had a concentration of 1.0 mol/L. The bag was then heat-sealed while pressure inside the bag was reduced, so that a nonaqueous electrolyte secondary battery 1 was prepared. The nonaqueous electrolyte secondary battery 1 had a design capacity of 20.5 mAh. The mixed solvent had a relative dielectric constant of 18.8.

### Example 2

### Preparation of Nonaqueous Electrolyte Secondary Battery Separator

A nonaqueous electrolyte secondary battery separator 2 was obtained as in Example 1, except that Aluminiumoxid/Titandioxid (Al₂O₃:TiO₂=85:15, solid solution) produced by Ceram GmbH was used as a metal oxide instead of Aluminiumoxid/Titandioxid (Al₂O₃: TiO₂=99:1, solid solution) produced by Ceram GmbH. The nonaqueous electrolyte secondary battery separator 2 had a film thickness of 18.9 μm.

<Preparation of Nonaqueous Electrolyte Secondary Battery>

A nonaqueous electrolyte secondary battery was prepared as in Example 1, except that the nonaqueous electrolyte secondary battery separator 2 was used as a nonaqueous electrolyte secondary battery separator. The nonaqueous electrolyte secondary battery thus prepared was referred to as a nonaqueous electrolyte secondary battery 2.

### Example 3

<Preparation of Nonaqueous Electrolyte Secondary Battery Separator>

A nonaqueous electrolyte secondary battery separator 3 was obtained as in Example 1, except that Aluminiumoxid/Titandioxid (Al₂O₃:TiO₂=60:40, solid solution) produced by Ceram GmbH was used as a metal oxide instead of Aluminiumoxid/Titandioxid (Al₂O₃: TiO₂=99:1, solid solution) produced by Ceram GmbH. The nonaqueous electrolyte secondary battery separator 3 had a film thickness of 18.4 μm.

<Preparation of Nonaqueous Electrolyte Secondary Battery>

A nonaqueous electrolyte secondary battery was prepared as in Example 1, except that the nonaqueous electrolyte secondary battery separator 3 was used as a nonaqueous electrolyte secondary battery separator. The nonaqueous electrolyte secondary battery thus prepared was referred to as a nonaqueous electrolyte secondary battery 3.

### Example 4

<Preparation of Nonaqueous Electrolyte Secondary Battery Separator>

Aluminiumoxid/Titandioxid (Al₂O₃:TiO₂=60:40, solid solution) produced by Ceram GmbH was ground for 4 hours in a vibrating mill, provided with an alumina pot having a capacity of 3.3 L and an alumina ball having a diameter φ of 15 mm, to obtain fine particles of the metal oxide. In a mortar, 99.9 parts by mass of the fine particles of the metal oxide and 0.1 parts by mass of barium titanate (produced by Nacalai Tesque) were mixed to obtain mixed fine metal oxide particles. A nonaqueous electrolyte secondary battery separator 4 was obtained as in Example 1, except that the mixed fine metal oxide particles were used as fine metal oxide particles. The nonaqueous electrolyte secondary battery separator 4 had a film thickness of 19.6 μm.

<Preparation of Nonaqueous Electrolyte Secondary Battery>

A nonaqueous electrolyte secondary battery was prepared as in Example 1, except that the nonaqueous electrolyte secondary battery separator 4 was used as a nonaqueous electrolyte secondary battery separator. The nonaqueous electrolyte secondary battery thus prepared was referred to as a nonaqueous electrolyte secondary battery 4.

### Example 5

<Preparation of Nonaqueous Electrolyte Secondary Battery Separator>

The nonaqueous electrolyte secondary battery separator 2 was used as a nonaqueous electrolyte secondary battery separator.

<Preparation of Positive Electrode Plate>

A surface of a positive electrode plate, identical to the positive electrode plate 1, which surface was located on a positive electrode mix layer side was rubbed 5 times with use of an abrasive cloth sheet (model: TYPE AA GRIT No. 100) produced by Nagatsuka Abrasive Mfg. Co. Ltd. Consequently, a positive electrode plate 2 was obtained. In the positive electrode plate 2, a positive electrode mix layer had a thickness of 38 μm and a porosity of 40%.

<Preparation of Nonaqueous Electrolyte Secondary Battery>

A nonaqueous electrolyte secondary battery was prepared as in Example 1, except that the nonaqueous electrolyte secondary battery separator 2 was used as a nonaqueous electrolyte secondary battery separator and the positive electrode plate 2 was used as a positive electrode plate. The nonaqueous electrolyte secondary battery thus prepared was referred to as a nonaqueous electrolyte secondary battery 5.

### Example 6

<Preparation of Nonaqueous Electrolyte Secondary Battery Separator>

The nonaqueous electrolyte secondary battery separator 2 was used as a nonaqueous electrolyte secondary battery separator.

<Preparation of Positive Electrode Plate>

The positive electrode plate 2 was used as a positive electrode plate.

<Preparation of Negative Electrode Plate>

A surface of a negative electrode plate, identical to the negative electrode plate 1, which surface was located on a negative electrode mix layer side was rubbed 3 times with use of an abrasive cloth sheet (model: TYPE AA GRIT No. 100) produced by Nagatsuka Abrasive Mfg. Co. Ltd. Consequently, a negative electrode plate 2 was obtained. In the negative electrode plate 2, a negative electrode mix layer had a thickness of 38 μm and a porosity of 31%.

<Preparation of Nonaqueous Electrolyte Secondary Battery>

A nonaqueous electrolyte secondary battery was prepared as in Example 1, except that the nonaqueous electrolyte secondary battery separator 2 was used as a nonaqueous electrolyte secondary battery separator, the positive electrode plate 2 was used as a positive electrode plate, and the negative electrode plate 2 was used as a negative electrode plate. The nonaqueous electrolyte secondary battery thus prepared was referred to as a nonaqueous electrolyte secondary battery 6.

### Example 7

<Preparation of Nonaqueous Electrolyte Secondary Battery Separator>

The nonaqueous electrolyte secondary battery separator 3 was used as a nonaqueous electrolyte secondary battery separator.

<Preparation of Negative Electrode Plate>

A surface of a negative electrode plate, identical to the negative electrode plate 1, which surface was located on a negative electrode mix layer side was rubbed 7 times with use of an abrasive cloth sheet (model: TYPE AA GRIT No. 100) produced by Nagatsuka Abrasive Mfg. Co. Ltd. Consequently, a negative electrode plate 3 was obtained. In the negative electrode plate 3, a negative electrode mix layer had a thickness of 38 μm and a porosity of 31%.

<Preparation of Nonaqueous Electrolyte Secondary Battery>

A nonaqueous electrolyte secondary battery was prepared as in Example 1, except that the nonaqueous electrolyte secondary battery separator 3 was used as a nonaqueous electrolyte secondary battery separator and the negative electrode plate 3 was used as a negative electrode plate. The nonaqueous electrolyte secondary battery thus prepared was referred to as a nonaqueous electrolyte secondary battery 7.

### Example 8

<Preparation of Nonaqueous Electrolyte Secondary Battery Separator>

The nonaqueous electrolyte secondary battery separator 4 was used as a nonaqueous electrolyte secondary battery separator.

<Preparation of Positive Electrode Plate>

A surface of a positive electrode plate, identical to the positive electrode plate 1, which surface was located on a positive electrode mix layer side was rubbed 3 times with use of an abrasive cloth sheet (model: TYPE AA GRIT No. 100) produced by Nagatsuka Abrasive Mfg. Co. Ltd. Consequently, a positive electrode plate 3 was obtained. In the positive electrode plate 3, a positive electrode mix layer had a thickness of 38 μm and a porosity of 40%.

<Preparation of Negative Electrode Plate>

A surface of a negative electrode plate, identical to the negative electrode plate 1, which surface was located on a negative electrode mix layer side was rubbed 5 times with use of an abrasive cloth sheet (model: TYPE AA GRIT No. 100) produced by Nagatsuka Abrasive Mfg. Co. Ltd. Consequently, a negative electrode plate 4 was obtained. In the negative electrode plate 4, a negative electrode mix layer had a thickness of 38 μm and a porosity of 31%.

<Preparation of Nonaqueous Electrolyte Secondary Battery>

A nonaqueous electrolyte secondary battery was prepared as in Example 1, except that the nonaqueous electrolyte secondary battery separator 4 was used as a nonaqueous electrolyte secondary battery separator, the positive electrode plate 3 was used as a positive electrode plate, and the negative electrode plate 4 was used as a negative electrode plate. The nonaqueous electrolyte secondary battery thus prepared was referred to as a nonaqueous electrolyte secondary battery 8.

### Comparative Example 1

<Preparation of Nonaqueous Electrolyte Secondary Battery Separator>

A nonaqueous electrolyte secondary battery separator 5 was obtained as in Example 1, except that fine particles of magnesium oxide (product name: Pyrokisuma (registered trademark) 500-04R, produced by Kyowa Chemical Industry Co., Ltd.) were used as fine metal oxide particles. The nonaqueous electrolyte secondary battery separator 5 had a film thickness of 23.7 μm.

<Preparation of Nonaqueous Electrolyte Secondary Battery>

A nonaqueous electrolyte secondary battery was prepared as in Example 1, except that the nonaqueous electrolyte secondary battery separator 5 was used as a nonaqueous electrolyte secondary battery separator. The nonaqueous electrolyte secondary battery thus prepared was referred to as a nonaqueous electrolyte secondary battery 9.

### Comparative Example 2

<Preparation of Nonaqueous Electrolyte Secondary Battery Separator>

A nonaqueous electrolyte secondary battery separator 6 was obtained as in Example 1, except that fine particles of high purity alumina (product name: AA-03, a purity of not less than 99.99%, produced by Sumitomo Chemical Co., Ltd.) were used as fine metal oxide particles. The nonaqueous electrolyte secondary battery separator 6 had a film thickness of 20.7 μm.

<Preparation of Nonaqueous Electrolyte Secondary Battery>

A nonaqueous electrolyte secondary battery was prepared as in Example 1, except that the nonaqueous electrolyte secondary battery separator 6 was used as a nonaqueous electrolyte secondary battery separator. The nonaqueous electrolyte secondary battery thus prepared was referred to as a nonaqueous electrolyte secondary battery 10.

### Comparative Example 3

<Preparation of Nonaqueous Electrolyte Secondary Battery Separator>

A nonaqueous electrolyte secondary battery separator 7 was obtained as in Example 1, except that fine particles of barium titanate (produced by Nacalai Tesque) were used as fine metal oxide particles. The nonaqueous electrolyte secondary battery separator 7 had a film thickness of 20.4 μm.

<Preparation of Nonaqueous Electrolyte Secondary Battery>

A nonaqueous electrolyte secondary battery was prepared as in Example 1, except that the nonaqueous electrolyte secondary battery separator 7 was used as a nonaqueous electrolyte secondary battery separator. The nonaqueous electrolyte secondary battery thus prepared was referred to as a nonaqueous electrolyte secondary battery 11.

### Comparative Example 4

<Preparation of Nonaqueous Electrolyte Secondary Battery Separator>

The nonaqueous electrolyte secondary battery separator 5 was used as a nonaqueous electrolyte secondary battery separator.

<Preparation of Negative Electrode Plate>

A surface of a negative electrode plate, identical to the negative electrode plate 1, which surface was located on a negative electrode mix layer side was rubbed 10 times with use of an abrasive cloth sheet (model: TYPE AA GRIT No. 100) produced by Nagatsuka Abrasive Mfg. Co. Ltd. Consequently, a negative electrode plate 5 was obtained. In the negative electrode plate 5, a negative electrode mix layer had a thickness of 38 μm and a porosity of 31%.

<Preparation of Nonaqueous Electrolyte Secondary Battery>

A nonaqueous electrolyte secondary battery was prepared as in Example 1, except that the nonaqueous electrolyte secondary battery separator 5 was used as a nonaqueous electrolyte secondary battery separator and the negative electrode plate 5 was used as a negative electrode plate. The nonaqueous electrolyte secondary battery thus prepared was referred to as a nonaqueous electrolyte secondary battery 12.

### Comparative Example 5

<Preparation of Nonaqueous Electrolyte Secondary Battery Separator>

The nonaqueous electrolyte secondary battery separator 7 was used as a nonaqueous electrolyte secondary battery separator.

<Preparation of Positive Electrode Plate>

A surface of a positive electrode plate, identical to the positive electrode plate 1, which surface was located on a positive electrode mix layer side was rubbed 10 times with use of an abrasive cloth sheet (model: TYPE AA GRIT No. 100) produced by Nagatsuka Abrasive Mfg. Co. Ltd. Consequently, a positive electrode plate 4 was obtained. In the positive electrode plate 4, a positive electrode mix layer had a thickness of 38 μm and a porosity of 40%.

<Preparation of Nonaqueous Electrolyte Secondary Battery>

A nonaqueous electrolyte secondary battery was prepared as in Example 1, except that the nonaqueous electrolyte secondary battery separator 7 was used as a nonaqueous electrolyte secondary battery separator and the positive electrode plate 4 was used as a positive electrode plate. The nonaqueous electrolyte secondary battery thus prepared was referred to as a nonaqueous electrolyte secondary battery 13.

[Measurement Results]

High-rate characteristics of the nonaqueous electrolyte secondary batteries 1 through 13, prepared in Examples 1 through 8 and Comparative Examples 1 through 5, were measured by the above-described method. Table 1 shows a result of measuring the high-rate characteristics.

TABLE 1

| | Nonaqueous | | | |
|---|---|---|---|---|
| | electrolyte | | | Nonaqueous |
| | secondary | Positive | Negative | electrolyte |
| | battery | electrode | electrode | secondary |
| | separator | plate | plate | battery |
| | Capacitance | Capacitance | Capacitance | High-rate |
| | per | per | per | characteristic |
| | measurement | measurement | measurement | (20 C.) |
| | area | area | area | discharge |
| | of 19.6 mm² | of 900 mm² | of 900 mm² | capacity |
| | [nF] | [nF] | [nF] | (mAh) |
| Example 1 | 0.0162 | 2.1 | 4.7 | 8.5 |
| Example 2 | 0.0169 | 2.1 | 4.7 | 8.9 |
| Example 3 | 0.0224 | 2.1 | 4.7 | 9.9 |
| Example 4 | 0.0225 | 2.1 | 4.7 | 13.2 |
| Example 5 | 0.0169 | 935 | 4.7 | 10.1 |
| Example 6 | 0.0169 | 935 | 274 | 9.3 |
| Example 7 | 0.0224 | 2.1 | 7300 | 10.8 |
| Example 8 | 0.0225 | 60.0 | 2540 | 14.8 |
| Comparative | 0.0118 | 2.1 | 4.7 | 1.3 |
| Example 1 | | | | |
| Comparative | 0.0143 | 2.1 | 4.7 | 6.3 |
| Example 2 | | | | |
| Comparative | 0.0231 | 2.1 | 4.7 | 3.2 |
| Example 3 | | | | |
| Comparative | 0.0118 | 2.1 | 9050 | 3.0 |
| Example 4 | | | | |
| Comparative | 0.0231 | 4090 | 4.7 | 3.6 |
| Example 5 | | | | |

From Table 1, it was found that the nonaqueous electrolyte secondary batteries 1 through 8, which were prepared in Examples 1 through 8 and each of which included (i) the nonaqueous electrolyte secondary battery separator having a capacitance of not less than 0.0145 nF and not more than 0.0230 nF per measurement area of 19.6 mm², (ii) the positive electrode plate having a capacitance of not less than 1 nF and not more than 1000 nF per measurement area of 900 mm², and (iii) the negative electrode plate having a capacitance of not less than 4 nF and not more than 8500 nF per measurement area of 900 mm², were more excellent in high-rate characteristic (discharge output characteristic) than the nonaqueous electrolyte secondary batteries 9 through 13, which were prepared in Comparative Examples 1 through 5 and each of which included the nonaqueous electrolyte secondary battery separator, the positive electrode plate, and the negative electrode plate at least one of which had a capacitance outside the above range.

### INDUSTRIAL APPLICABILITY

A nonaqueous electrolyte secondary battery in accordance with an embodiment of the present invention is excellent in discharge output characteristic (high-rate characteristic). Further, a nonaqueous electrolyte secondary battery positive electrode plate in accordance with an embodiment of the present invention, a nonaqueous electrolyte secondary battery negative electrode plate in accordance with an embodiment of the present invention, and a nonaqueous electrolyte secondary battery member in accordance with an embodiment of the present invention can be each used to produce a nonaqueous electrolyte secondary battery which is excellent in discharge output characteristic (high-rate characteristic).

1. A nonaqueous electrolyte secondary battery comprising:
a positive electrode plate;
a nonaqueous electrolyte secondary battery separator; and
a negative electrode plate,
the nonaqueous electrolyte secondary battery separator having a capacitance of not less than 0.0145 nF and not more than 0.0230 nF per measurement area of 19.6 mm²,
the positive electrode plate having, by itself, a capacitance of not less than 1 nF and not more than 1000 nF per measurement area of 900 mm²,
the negative electrode plate having, by itself, a capacitance of not less than 4 nF and not more than 8500 nF per measurement area of 900 mm².

2. The nonaqueous electrolyte secondary battery as set forth in claim 1, wherein the positive electrode plate contains a transition metal oxide.

3. The nonaqueous electrolyte secondary battery as set forth in claim 1, wherein the negative electrode plate contains graphite.

4. A nonaqueous electrolyte secondary battery positive electrode plate having a capacitance of not less than 1 nF and not more than 1000 nF per measurement area of 900 mm².

5. A nonaqueous electrolyte secondary battery negative electrode plate having a capacitance of not less than 4 nF and not more than 8500 nF per measurement area of 900 mm².

6. A nonaqueous electrolyte secondary battery member comprising:
a positive electrode plate;
a nonaqueous electrolyte secondary battery separator; and
a negative electrode plate,
the positive electrode plate, the nonaqueous electrolyte secondary battery separator, and the negative electrode plate being disposed in this order,
the nonaqueous electrolyte secondary battery separator having a capacitance of not less than 0.0145 nF and not more than 0.0230 nF per measurement area of 19.6 mm²,
the positive electrode plate having, by itself, a capacitance of not less than 1 nF and not more than 1000 nF per measurement area of 900 mm²,
the negative electrode plate having, by itself, a capacitance of not less than 4 nF and not more than 8500 nF per measurement area of 900 mm².
